(19) United States
(12) Patent Application Publication
(10) Pub. No.: US 2009/0191839 A1
(43) Pub. Date: Jul. 30, 2009

(54) PERSONAL ALARM AND SERVEILLANCE SYSTEM

(76) Inventor: Thomas Calvin Cannon, JR., La Plata, MD (US)

Correspondence Address: Thomas Calvin Cannon, Jr., 1010 Eastbourne Drive, La Plata, MD, 20646, US

(21) Appl. No.: 12/020,663

(22) Filed: Jan. 28, 2008

(51) Int. Cl. H04M 11/04; H04Q 7/00

(52) U.S. Cl. 455/404.1; 340/539.11

(57) ABSTRACT

The present invention is a system for observing stationary and mobile subjects and sending alarms and initiating remedial actions at the observation site by using an observation device, having the recording, and communications capabilities typically found in cell phones, to observe the subject and send recordings and relay alarm signals directly to a controller device possessed by the user. The controller device has the recording and communications capabilities typical of cell phones and allows users to review the data from the observation device and take appropriate actions. Such actions include commanding the observation unit to activate on-site devices that can mitigate damage, issuing an alarm to appropriate emergency response units, and augmenting data sent to emergency response units with the subject's location and descriptive information that can help responders arrive at the scene quicker and act more effectively when they arrive.

### BACKGROUND OF THE INVENTION

This invention relates to systems for remotely observing areas of interest, including one's immediate surroundings, and taking actions based on what is observed to preserve the safety of the person or object under surveillance. More particularly, this invention relates to using a cell phone to record audio, video and other data pertaining to an area under surveillance and sending such recordings directly to a second cell phone, where the user may take appropriate actions. Such actions may include, for example, sending alarms to emergency response units, storing the incoming video on either a local or remote storage servers, or issuing a command to the first cell phone to execute actions at the surveillance site. This phone-to-phone system is far less complex and costly than conventional alarm and surveillance systems, can be used to observe and protect mobile subjects as well as stationary ones, reduces the likelihood of false alarms, and allows users to remotely, on-command, interdict hostile actions occurring at the surveillance site.

Conventional alarm and surveillance systems are usually geographically fixed and typically observe stationary areas, making them poorly suited for protecting mobile subjects. Video recordings and other data from such systems are either stored locally or stored at remote observation sites. Although such systems are effective in detecting disturbances and initiating alarms for stationary areas, their size and complexity make them unsuitable for continually observing areas that are either mobile (i.e. moving) or are not controlled by the observer. The area surrounding a pedestrian walking down a dark street is an example of a mobile observation area. The areas surrounding a person in an elder care center and a child in a daycare center are examples of areas that may not be controlled by the remote observer. Mobile observation areas and observation areas not controlled by the observer require mobile and compact recorders and sensors. Conventional alarm and surveillance systems are usually not required to update the location of the surveillance area because their surveillance areas are usually geographically fixed. On the other hand, alarm and surveillance systems intended to protect mobile people or objects must be capable of continually updating and reporting the geographical location of the person or object.

Two major problems with conventional alarm systems are their susceptibility to tampering and their high frequency of false alarms. Cleaver thieves have exploited these weaknesses to steal multimillion dollar paintings and other valuables from seemingly well-protected premises. Systems that employ fixed surveillance equipment and use land lines to relay alarm signals to authorities are the ones most vulnerable to tampering. Both of these system elements have less protection than the subjects that they guard and may be short circuited or have their signals replaced with bogus ones. A high frequency of false alarms can be just as debilitating as tampering. The current rate of false alarms is so high that local municipalities routinely assess a False Alarm Response Fee on homes protected by burglar alarm systems. Because the cost of such fees increases with the number of false alarms, security system providers often intercept alarms and attempt to contact owners and validate alarms before forwarding them to local authorities. This interdiction by a third party drives up the cost of maintaining a home alarm system and simultaneously slows down the response time.

Another shortcoming of conventional alarm and surveillance systems is that they mostly respond to disturbances of inanimate objects, such as doors, windows, space, and, in the case of smoke alarms, air. Exceptions include medical alert systems that monitor bodily functions and generate alarms when functions fall outside specified ranges. However, neither burglar alarms nor health monitoring systems combine both environmental data and biological data to assess threats and generate alarms based on the nature of the perceived threat. The ability to send an alarm based on biological data is important for personal security systems (i.e. systems designed to protect people versus property) because victims may not have enough time to manually send alarms when suddenly attacked. In such situations, biological data, such as elevated heart rate or respiratory rate, might be used to trigger alarms. Another advantage of biologically-triggered alarms is that victims do not have to perform overt actions to generate distress signals, greatly reducing the chances of retaliatory actions by assailants. Alarms that combine biological data and environmental data (such as audio visual information and location data) can help emergency response teams respond quicker and more effectively to alarms.

Finally, conventional alarm and surveillance systems do not transmit descriptive information on the subject under duress. Such information may not by necessary for systems designed to protect stationary property, but is valuable for systems designed to protect mobile people because it helps law enforcement officers more quickly distinguish between victims and attackers when they arrive on the scene.

### BRIEF SUMMARY OF THE INVENTION

A system for increasing a subject's safety by monitoring their surroundings using one cell phone or similar device and sending the data directly to a second cell phone for scrutiny and further actions. Data transmission from the observer cell phone can be initiated either on command by the user of the second cell phone or triggered automatically by events occurring at the observation site. Such events may include, for example, appearance of an intruder, a noise, or disturbance of the observer cell phone. In response to phone messages from the controller cell phone, the observer cell phone can send signals that activate devices located at the observation site that take action to mitigate threats. Such actions include, for example, sounding an alarm, triggering a fire extinguisher, releasing a repellant agent, or turning on lights. The observer cell phone is also capable of placing phone calls to local response teams, either automatically in response to a local event, or on command from the controller cell phone. The controller cell phone can store data received from the observer cell phone either locally or on a remote machine. The controller cell phone can also relay data from the observer cell phone to appropriate response teams, either automatically or on command. The controller cell phone may augment data relayed to response teams with pre-programmed descriptive information on the subject under observation. Such information may include, for example, the sex, age, height, and clothing color of the subject threatened.

At the option of the user, the system may be configured to simultaneously send data from the observer cell phone to both the controller cell phone and a remote storage server. Such a configuration may be useful when the observer cell phone is collocated with the controller cell phone and there is danger of the controller cell phone becoming either inoperable or unavailable. Similarly, as with conventional systems, the personal alarm and surveillance system may be programmed to send alarms from the observer cell phone directly to emergency response teams, relieving the user from manually relaying such alarms.

### BRIEF DESCRIPTION OF THE DRAWINGS

FIG. 1 is a schematic of the personal alarm and surveillance system for a stationary subject remotely located from the user of the system. FIG. 1 shows the observer cell phone, 1, a local monitoring device, 2, in the form of a smoke detector, a local response device, 3, in the form of a fire alarm, the controller cell phone, 4, the controller cell phone data storage card, 5, and a remote data storage server, 6. FIG. 2 is a schematic of the personal alarm and surveillance system when the subject under surveillance is the user, and the user is mobile. FIG. 2 depicts the observer cell phone, 1, attached to the user's rear collar, 7, a local monitoring device, 2, in the form of a wrist band that monitors pulse rate, a local response device, 3, in the form of an air horn, the controller cell phone, 4, the controller cell phone data storage card, 5, and a remote data storage server, 6. FIG. 3 is a diagram depicting the simultaneous transmission of monitoring and alarm data from the observer cell phone, 1, and a local monitoring device, 2, to a remote storage server, 6, and the controller cell phone, 4. This monitoring and alarm data is augmented by supplemental data from the data storage card, 5, and relayed to an emergency response unit, 8.

### DETAILED DESCRIPTION OF THE INVENTION

Four key features of the present invention are (1) use of the highly reliable and secure public switched telephone network (PSTN) to transmit data wirelessly directly from the surveillance site to the user, bypassing an intermediate third party, (2) use of a controller cell phone to command a cell phone-type device located at the surveillance site to capture and relay observation information to other system components, (3) use of the same system to observe both stationary and mobile subjects, and (4) augmentation of data collected at the observation site with additional data about the person or object under surveillance that can help emergency responders react to disturbances more quickly and more effectively.

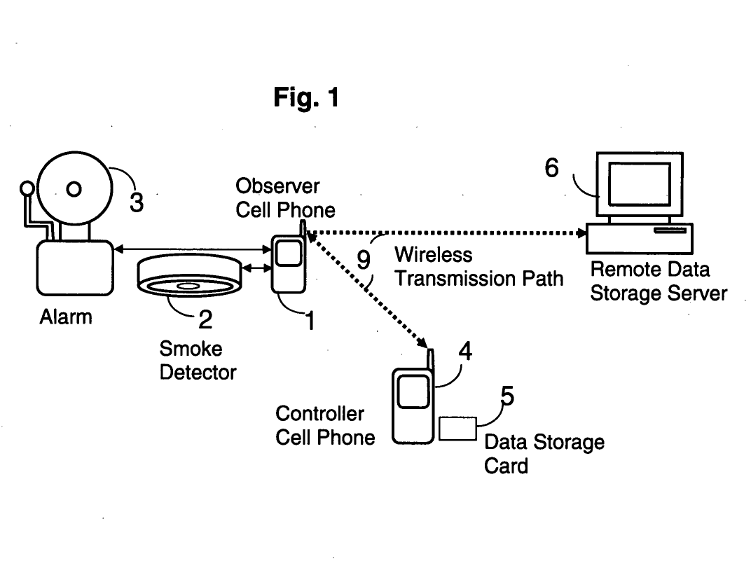

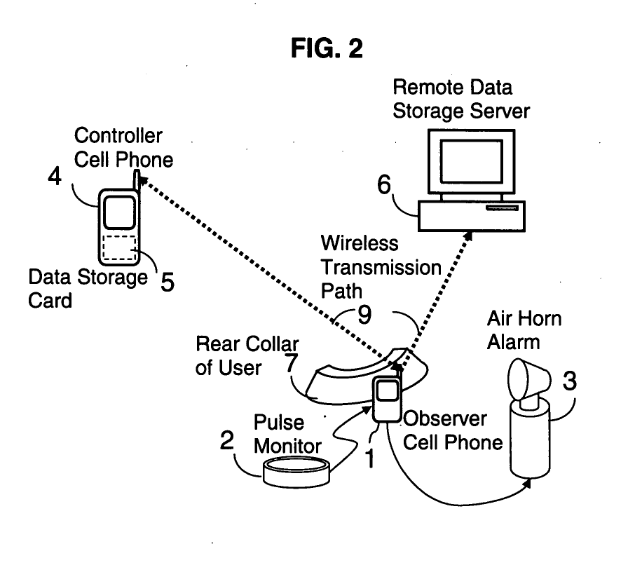

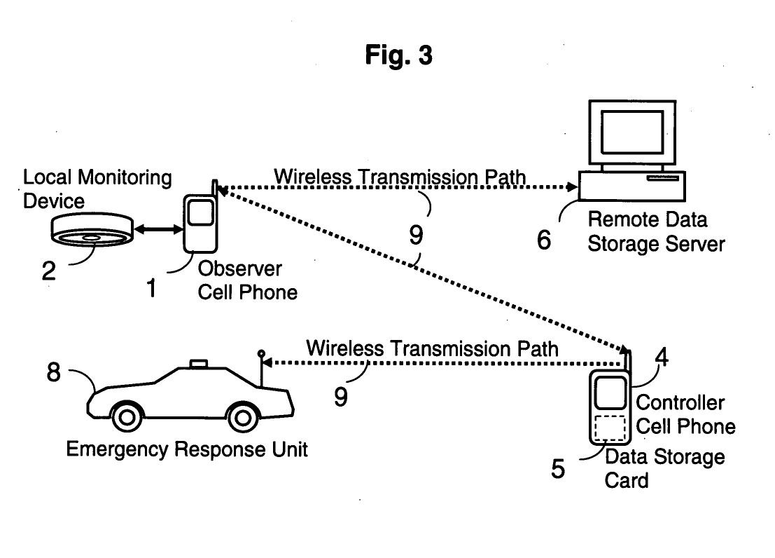

FIG. 1 is a schematic of the preferred embodiment of this invention when the subject under surveillance is stationary. The stationary subject may be a person, place, or thing, including a structure, portion of a structure, or area inside or outside a structure. The observer cell phone, 1, captures audio data, video data, or both using the sensors built into the cell phone. The observer cell phone is mounted in a suitable position to observe the subject and is electrically connected to a battery charger so that the observer cell phone, 1, is always available to record and relay data. The observer cell phone, 1, is equipped with input ports for receiving data from external devices, and output ports for controlling the actions of external devices. Data from external devices, such as a smoke detector, 2, and an alarm, 3, are fed to the observer cell phone, 1, through the input ports. When instructed to do so, the observer cell phone, 1, forwards data from both internal and external monitoring devices to the controller cell phone, 4, and remote data storage server, 6. The dashed lines, 9, indicate wireless transmission paths. The data from external devices is integrated with the audio and video data generated by the observer cell phone, 1, by superimposing the device code and activation state of each device along one edge of the video output screen. For example, the first digit of the code could designate the device and the second digit of the code could designate the device's activation state, with a “0” indicating “active” and a “1” indicating “inactive.” With such a code, a string of digits “20 31” along the bottom of the video screen would indicate that the second device, the smoke detector, 2, was activated while the burglar alarm, 3, was inactive.

The observer cell phone, 1, is configured to accept commands from the controller cell phone, 2, by means of text messaging. The observer cell phone, 1, automatically opens and reads text messages from the controller cell phone, 4, and executes actions based on the content of the messages. The ringer of the observer cell phone, 1, is silenced except when it is used as a built-in alarm device in lieu of an external alarm.

The controller cell phone, 4, controls the actions of the observer cell phone, 1, thorough text messages. For example, a message of “10” could turn on the observer cell phone, 1, while a message of “11” might turn it off. Other text messages direct the observer cell phone, 1, to send activation or deactivation signals to connecting devices, and to forward monitoring data to the remote data storage server, 6. For example, a code of “30” could be programmed to sound the burglar alarm, 3, and a code of “31” could turn off the burglar alarm, 3. Similarly, a code of “00” could cause the ringer of observer cell phone, 1, to sound at its maximum volume.

The controller cell phone, 4, acts as the control center for the alarm and surveillance system with its principal role being to synthesize data from various inputs, filter it, and send alarms to pre-programmed numbers to evoke the appropriate emergency response unit, depending on the nature of the threat. Fire alarms would be relayed to fire departments while burglar alarms would be relayed to police departments, for example. The controller cell phone, 4, is equipped with a data storage card, 5, to archive data received from the observer cell phone, 1. Such data may be useful for apprehending burglars or reconstructing the causes of fires or other events.

FIG. 2 is a schematic of the preferred embodiment of this invention when the subject under surveillance is either mobile or resides in a area that does not allow permanent mounting of the observer cell phone, 1. The subject may be a person, place, or thing, including animals, vehicles and areas inside or outside structures. The observer cell phone, 1, captures audio data, video data, or both using the sensors built into the cell phone. The observer cell phone is mounted on or near the subject in a suitable position to observe either the subject or the subject's blind spots. In FIG. 2 the observer cell phone, 1, is mounted on the subject's rear collar and covers the blind spot behind the subject. Alternatively, the observer cell phone, 1, could be mounted on the rear of the subject's belt, hat, or other article of clothing. The observer cell phone, 1, is equipped with output and input ports for sending and receiving signals to and from external devices. For example, data from a heart rate monitor might be used to automatically send a distress signal to either the remote data storage device, 6, the controller cell phone, 4, or an emergency response unit. The dashed lines, 9, indicate wireless transmission paths. That same distress signal could be used to activate the air horn alarm, 3, that is wired to the observer cell phone, 1, and mounted on the user's belt or other convenient point. At the user's option, the system may be used without any of the auxiliary devices such as the pulse monitor, 2, or the air horn, 3, only keeping the observer cell phone, 1, and the controller cell phone, 4, on his or her person.

The controller cell phone, 4, commands the observer cell phone, 1, to upload data to the controller cell phone, 4, and, when desired to the remote data storage server, 6. The data from external devices is integrated with the audio and video data generated by the observer cell phone, 1, by superimposing the device code and activation state of each device along one edge of the video output screen.

FIG. 3 depicts the complete communications links between devices located at the surveillance scene and other communications devices that either receive or relay data. Data originates from the monitoring systems at the surveillance scene, the observer cell phone, 1, and the local monitoring device, 2. This data is sent over a wireless link to the controller cell phone, 4, and, on command from the controller cell phone, 4, is also sent to the remote data storage server, 6. After reviewing the data, the user decides whether to command the observer cell phone, 1, to execute some local action, and also decides whether to issue an alarm to an emergency response unit, 8. Alarm messages sent to emergency response units, 8, are pre-composed and augmented with supplemental data about the subject that can help responders reach the area more quickly and perform more effectively once they reach the scene of the disturbance. Such information includes, for example, the subject's location, sex, age, height, and clothing color. The content of the pre-composed messages is tailored for the type of emergency response unit, 1, being contacted.

Numerous modifications to and alternative embodiments of the present invention will be apparent to those skilled in the art in view of the foregoing description. Accordingly, this description is to be construed as illustrative only and is for the purpose of teaching those skilled in the art the best modes of carrying out the invention. Details of the structure may be varied substantially without departing from the spirit of the invention and the exclusive use of all modifications which come within the scope of the appended claims is reserved.

What I claim as my invention is:

1. A system for observing a person, object or area comprising;
a first wireless device capable of capturing audio or video data of an area or subject under surveillance and having the ability to send and receive wireless telephone calls,
a second wireless device capable of sending and receiving audio or video data directly to and from the first device and capable of placing calls on a public switched network system,
a means for the second wireless devise to control the operation of the first wireless device based on the content of the messages sent from the second wireless device to the first wireless device.

2. A system according to claim 1, further comprising electro-mechanical devices at the surveillance site that are capable of sending and receiving signals to and from the first wireless device and provide;
a means for sensing and reporting additional attributes of the object under surveillance other than and those sensed by the first wireless device,
a means for taking actions to mitigate unwanted conditions at the observation site,
a means for sounding an alarm at the observation site.

3. A system according to claim 2, further comprising a means for either the first wireless device or the second wireless device to forward surveillance information and alarms to emergency responders, including law enforcement authorities

4. A system according to claim 3, further comprising a means for either the first wireless device or the second wireless device to forward data collected at the observation site to a remote server where it may be stored and processed

5. A system according to claim 4, further comprising a means for augmenting data collected at the observation site with;
information on the location of the person or object under surveillance,
distinguishing characteristics of the person or object under surveillance, such as sex, age, weight and other personal characteristics.

6. A system according to claim 5 in which alarms and mitigation devices are triggered automatically when sensors at the surveillance site record readings that are outside the pre-determined safe bounds for the person or object under surveillance.
